(19) United States
(12) Patent Application Publication
(10) Pub. No.: US 2026/0005543 A1
(43) Pub. Date: Jan. 1, 2026

(54) ELECTRONIC DEVICE

(71) Applicant: QISDA (SUZHOU) CO., Ltd., Suzhou (CN)

(72) Inventor: Wan He Qiu, Suzhou (CN)

(73) Assignee: QISDA (SUZHOU) CO., Ltd., Suzhou (CN)

(21) Appl. No.: 19/172,632

(22) Filed: Apr. 7, 2025

(30) Foreign Application Priority Data
Jun. 28, 2024 (CN) 202421520807.3

(51) Int. Cl. H02J 13/00

(52) U.S. Cl. CPC H02J 13/00001; H02J 13/00002; H02J 13/00016; H02J 13/00026

(57) ABSTRACT

An electronic device includes a plurality of electrical modules, a storage module, a circuit monitoring module and a processing module. The plurality of electrical modules at least includes a display module. The storage module is adapted to store designed total power consumption of the electronic device. The circuit monitoring module is respectively coupled to the plurality of electrical modules, and adapted to immediately acquire switching statuses of the plurality of electrical modules and real-time current of each of switched-on electrical modules. The processing module analyzes and acquires real-time power consumption corresponding to the electrical modules and real-time total power consumption of the electronic device in accordance with the real-time current of each switched-on electrical module. The processing module further determines whether to activate a protection mode in accordance with the real-time total power consumption and the designed total power consumption.

### BACKGROUND OF THE INVENTION

### 1. Field of the Invention

The present application relates to an electronic device, and more particularly, to an electronic device having a visual interface for power consumption management.

### 2. Description of the Prior Art

With the advanced technology, the electronic device on the market is usually equipped with a plurality of electrical modules. The electronic device has the upper limit of power consumption. The power consumption of the electronic device may exceed the upper limit and cause damage to the electronic device due to long-term and high-load operation. The foresaid high-load operation usually means that most of the electrical modules of the electronic device are operated in the higher power consumption at the same time, and the switched-on electrical modules have higher total power consumption.

Therefore, power consumption of each electrical module of the electronic device needs to be monitored. When the total power consumption of the switched-on electrical module is close to the upper limit of the power consumption, some of the electrical modules are switched off to protect the circuit. However, the conventional power consumption monitoring technology is automatically executed by the electronic device, and the user cannot realize the current working status of each electrical module and the remaining power consumption of the electronic device; besides, although some conventional electronic device can provide the power consumption level of each installed software, the conventional electronic device cannot provide the power consumption of hardware corresponding to each software for the user. Therefore, design of an electronic device of clearly showing the current working status and the real-time power consumption of each electrical module is an important issue in the related industry.

### SUMMARY OF THE INVENTION

The present application provides an electronic device having a visual interface for solving above drawbacks.

According to the claimed application, the present application provides an electronic device including a plurality of electrical modules at least including a display module, a storage module adapted to store designed total power consumption of the electronic device, a circuit monitoring module respectively coupled to the plurality of electrical modules and adapted to immediately acquire switching statuses of the plurality of electrical modules and real-time current of each of switched-on electrical modules, and a processing module coupled to the storage module and the circuit monitoring module, and adapted to analyze and acquire real-time power consumption corresponding to the electrical modules and real-time total power consumption of the electronic device in accordance with the real-time current of each of the switched-on electrical modules. The processing module is adapted to further determine whether to activate a protection mode in accordance with the real-time total power consumption and the designed total power consumption. The processing module is further coupled to the display module and adapted to control the display module to display information, and the information includes the switching statuses and the real-time power consumption of the plurality of electrical modules, the real-time total power consumption, and at least one of the designed total power consumption and total power consumption margin.

According to the claimed application, the electronic device further includes an input module adapted to be operated for inputting an operation command, the operation command is adapted to change the switching statuses of the plurality of electrical modules, and/or adjust a power consumption level of each of the electrical modules.

According to the claimed application, the displayed information further includes a plurality of switch controls, the plurality of switch controls includes switch controls of at least parts of the plurality of electrical modules, and/or power consumption mode adjusting controls of the plurality of electrical modules; the plurality of switch controls is respectively operated for inputting a corresponding operation command.

According to the claimed application, the displayed information further includes a preset mode control adapted to be operated for inputting a corresponding operation command, so as to adjust each of the electrical modules to a preset switching status and/or a preset power consumption level.

According to the claimed application, the storage module is adapted to further store a preset priority level and a total power consumption margin preset value of each of the electrical modules; the protection mode includes: the processing module downgrades the real-time total power consumption when determining a power consumption difference between the designed total power consumption and the real-time total power consumption is smaller than or equal to the total power consumption margin preset value, which is interpreted as: firstly switching off at least one electrical module with a high priority level; or, firstly downgrading a power consumption level of at least one electrical module with the high priority level.

According to the claimed application, the protection mode further includes: the processing module further confirms whether the electrical module with the high priority level has multiple power consumption levels; the processing module switches off the electrical module with the high priority level and not having the multiple power consumption levels; and the processing module downgrades the power consumption level of the electrical module with the high priority level and having the multiple power consumption levels.

According to the claimed application, the protection mode further includes: the processing module further confirms an adjusted power consumption difference when confirming the power consumption difference between the designed total power consumption and the real-time total power consumption is smaller than or equal to total power consumption margin preset value and adjusting the real-time total power consumption, and downgrades the power consumption level of the electrical module with highest priority again when the adjusted power consumption difference is smaller than or equal to total power consumption margin preset value.

According to the claimed application, the protection mode further includes: the processing module further confirms an adjusted power consumption difference when confirming the power consumption difference between the designed total power consumption and the real-time total power consumption is smaller than or equal to total power consumption margin preset value and adjusting the real-time total power consumption, and switches off the electrical module with second highest priority or downgrades the power consumption level of the electrical module with the second highest priority when the adjusted power consumption difference is smaller than or equal to total power consumption margin preset value.

According to the claimed application, the electronic device further includes a battery adapted to provide electrical energy for the plurality of electrical modules, and the circuit monitoring module is coupled to the battery and adapted to acquire real-time electrical capacity of the battery; the information displayed on the display module further includes a battery endurance of the electronic device in accordance with the real-time total power consumption.

According to the claimed application, the plurality of electrical modules further includes one or some of an audio module, a network signal transmission module and a connector module.

Comparing to the prior art, the electronic device provided by the present application can include the plurality of electrical modules, the storage module, the circuit monitoring module and the processing module. The plurality of electrical modules can at least include the display module. The storage module can store the designed total power consumption of the electronic device. The circuit monitoring module can be respectively coupled to the plurality of electrical modules, and acquire the switching status of the plurality of electrical modules and the real-time current of the switched-on electrical module in real time. The processing module can analyze and acquire the real-time power consumption of the corresponding electrical module and the real-time total power consumption of the electronic device, in accordance with the real-time current of each switched-on electrical module; the processing module can determine whether to activate the protection mode based on the real-time total power consumption and the designed total power consumption. The processing module can be further coupled to the display module, and used to control the display module to display the information. The information can include the switching status, the real-time power consumption, the real-time total power consumption, and at least one of the designed total power consumption and the total power consumption margin of the plurality of electrical modules.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the present application.

FIG. 2 is a visual interface according to the embodiment of the present application.

FIG. 3 is a flow chart of the processing module controlling each electrical module according to the embodiment of the present application.

FIG. 4 is a flow chart of the processing module controlling each electrical module according to another embodiment of the present application.

### DETAILED DESCRIPTION

For further understanding of purposes, structures, features, and functions of the present application, the following detailed description is provided in conjunction with the related embodiments.

Certain terms are used to refer to particular components in the specification and claims. A person with general knowledge in the field can realize that the manufacturers may use different terms to refer to the same component. The present application does not distinguish the components by name, and utilizes functional difference of the components for distinction. The term “including” mentioned in the specification and claims should be interpreted as “including but not limited to”.

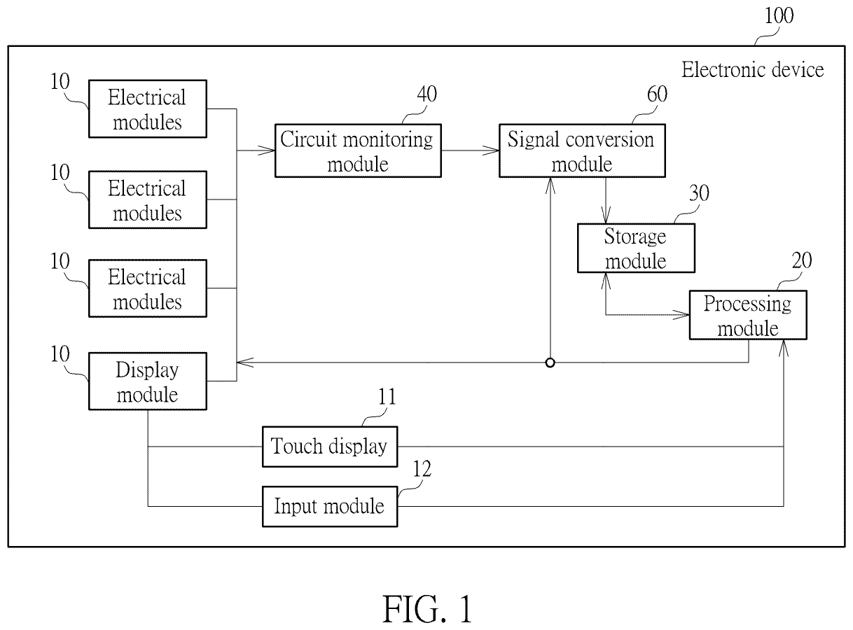

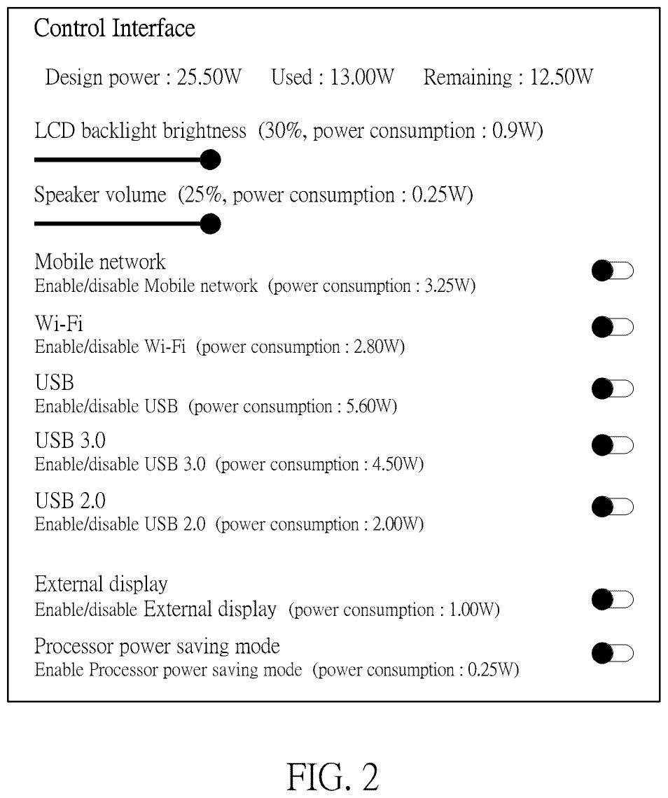

The present application provides an electronic device 100. Please refer to FIG. 1. The electronic device 100 can include a plurality of electrical modules 10, a processing module 20, a storage module 30 and a circuit monitoring module 40. At least one of the plurality of electrical modules 10 can be a display module 10. The display module 10 can include a backlight unit used to provide backlight for a liquid crystal display (LCD) panel. For example, as shown in FIG. 2, other electrical modules 10 of the electronic device 100 can include at least one or some of an audio module 10 (for speaker volume), a network signal transmission module 10 (for mobile network and Wi-Fi), and a connector module 10 (for USB, USB3.0 and USB2.0); the present application is not limited to the foresaid embodiments. The processing module 20 can generate an image signal of information displayed on the display module 10 in accordance with an actual operation situation of the plurality of electrical modules 10. The processing module 20 can be a central processing unit (CPU). The processing module 20 can transmit the image signal to the display module 10, and the display module 10 can display the information, so as to provide visual operation information of each of the electrical modules 10 for the user.

Specifically, the storage module 30 can be the storage media, such as a hard disk, and a configuration file stored in the storage module 30 can be computer programs. The processing module 20 can read the computer programs and execute a corresponding command; an execution result can be output as the image signal, and the display module 10 can display the image in accordance with the image signal. The foresaid information can be contained by the image. In the embodiment, the configuration file can include designed total power consumption of the electronic device 100. The designed total power consumption can be maximal power consumption provided by a circuit system of the electronic device 100. It should be mentioned that the designed total power consumption can be a constant value; for example, the designed total power consumption can be set in the form of code and attached to the foresaid computer programs, and the specific value of the designed total power consumption can be measured by a person skilled in the art via experiments, and the present application is not limited to the foresaid embodiment. The circuit monitoring module 40 can be coupled to each of the electrical module 10 respectively. The circuit monitoring module 40 can be a programmable gain amplifier (PGA) and used to acquire a switching status of each of the electrical modules 10 and real-time current (or voltage) of each switched-on electrical module 10 of the electronic device 100 immediately or in real time. Based on the above description, the processing module 20 can be coupled to the storage module 30 and the circuit monitoring module 40 respectively. Based on the designed total power consumption stored in the storage module 30 and the real-time current of each switched-on electrical module 10 acquired by the circuit monitoring module 40, the processing module 20 can analyze and acquire real-time power consumption of the corresponding electrical module 10 and real-time total power consumption of the electronic device 100, so as to generate the image signal corresponding to the visual displayed information, and further to transmit the image signal to the display module 10 for displaying the visual interface.

In one example, the processing module 20 can include a timer. The processing module 20 can compute and acquire the real-time power consumption of each switched-on electrical module by the timer and the real-time current (or the voltage) of each switched-on electrical module, as shown in FIG. 2, the displayed information of the display module 10 can include the switching status of each electrical module 10, the real-time power consumption of each switched-on electrical module 10, the real-time total power consumption of the electronic device 100, and at least one of the designed total power consumption and total power consumption margin of the electronic device 100. The real-time total power consumption can be a sum of the real-time power consumption of all of the switched-on electrical modules 10. The total power consumption margin can be margin of the real-time total power consumption compared with the designed total power consumption, which means the circuit of the electronic device 100 may be damaged when the real-time total power consumption is increased and exceeds over the total power consumption margin. The user can clearly realize an operation status of each electrical module 10 and the remaining power consumption of the electronic device 100, for reasonable using of the electronic device 100 and enhancing user experience. In the meantime, the processing module 20 can determine whether to activate a protection mode in accordance with the real-time total power consumption and the designed total power consumption, and can automatically downgrade the power consumption of the electronic device 100 for protecting the circuit when the real-time total power consumption is close to or similar to the designed total power consumption. In some embodiments, the electronic device 100 can further include a signal conversion module 60. It is understandable that the processing module 20 cannot directly analyze and compute an analog device signal acquired by the circuit monitoring module 40. The signal conversion module 60 can be coupled to the processing module 20 and the circuit monitoring module 40. The signal conversion module 60 can be an analogue to digital converter (ADC), and used to convert the analog signal into a digital device signal, and the processing module 20 can acquire and analyze the digital device signal.

In the preferred embodiment, the electronic device 100 can further include an input module 12 coupled to the display module 10. For example, a touch display 11 can be disposed on position corresponding to the LCD panel of the display module 10, and the user can touch the image displayed on the LCD panel for operation, and the present application is not limited to the foresaid embodiment. The input module 12 can be further coupled to the processing module 20. When the touch display 11 is operated, the input module 12 can be synchronously operated to input an operation command, for adjusting the switching status of each electrical module 10 and/or a power consumption level of each electrical module 10. In the embodiment, the signal conversion module 60 can be further coupled to each electrical module 10; the processing module 20 can generate a digital control signal for adjusting each electrical module 10 when analyzing the operation command, and the signal conversion module 60 can receive the digital control signal, and convert the digital control signal into an analog control signal.

Preferably, the displayed content of the display module 10 can further include a plurality of switch controls; the plurality of switch controls can respectively correspond to each electrical module 10, for adjusting the switching status and/or the power consumption level of each electrical module 10. Specifically, the plurality of switch controls can include the switch controls of the at least parts of plurality of electrical modules 10, and/or one or some power consumption mode adjusting controls of the plurality of electrical modules 10. For example, the user can touch position of the touch display 11 corresponding to the plurality of switch controls, and can accordingly operate the plurality of switch controls, so that the input module 12 can generate the operation command for adjustment of the switching status and/or the power consumption level of the corresponding electrical module 10; the present application is not limited to the foresaid embodiment. It should be mentioned that the switch controls of at least parts of the electrical module 10 can substantially be the change-over switch, and used to respectively change the switching status of the electrical modules 10 with functions of the mobile network, Wi-Fi, USB, USB3.0 and USB2.0. The foresaid adjusting controls of the electrical module 10 can substantially be the real-time power consumption adjusting slider of the electrical module 10, which means the adjusting slider can be the slide switch and used to adjust the speaker volume and the backlight brightness, so as to change the real-time power consumption of the audio module 10 or the display module 10. In other embodiments, the electrical module 10 can further include the connector module 10 coupled to an external display, and the corresponding switch controls can include the change-over switch for switching on (or enable) or switching off (or disable) the external display; the present application is not limited to the foresaid embodiment. Therefore, the user who has higher requirement for the electronic device 100 can decide the switch or the real-time power consumption of each electrical module 10 in accordance with the personal demand. The user can reasonably arrange the working status of each electrical module 10 in accordance with the visual information of circuit power consumption.

Preferably, the displayed content of the display module 10 can also include a preset mode control; when the preset mode control is operated, the input module 12 can be synchronously operated for inputting the corresponding operation command, for adjusting a preset switching status and/or a preset power consumption level of each electrical module 10. A manner of operating the preset mode control can refer to the foresaid description, and a detailed description is omitted herein for simplicity. For example, as shown in FIG. 2, the preset mode can be a power saving mode of the processor; the preset mode control can be operated for switching on the power saving mode, and the real-time power consumption of the processor of the electronic device 100 can be minimized. In other embodiment, the preset mode can be a system optimal mode (such as an operation frequency of the processing module 20 being adjusted to a specific frequency, and the backlight brightness being adjusted to specific brightness), an optimal display mode (such as the backlight brightness being adjusted to the specific brightness), a prolonged battery endurance mode (such as switching off the connector module 10 and the network signal transmission module 10, and reducing the operation frequency of the processing module 20), or any other preset modes according to the actual need. The present application is not limited to the foresaid embodiment.

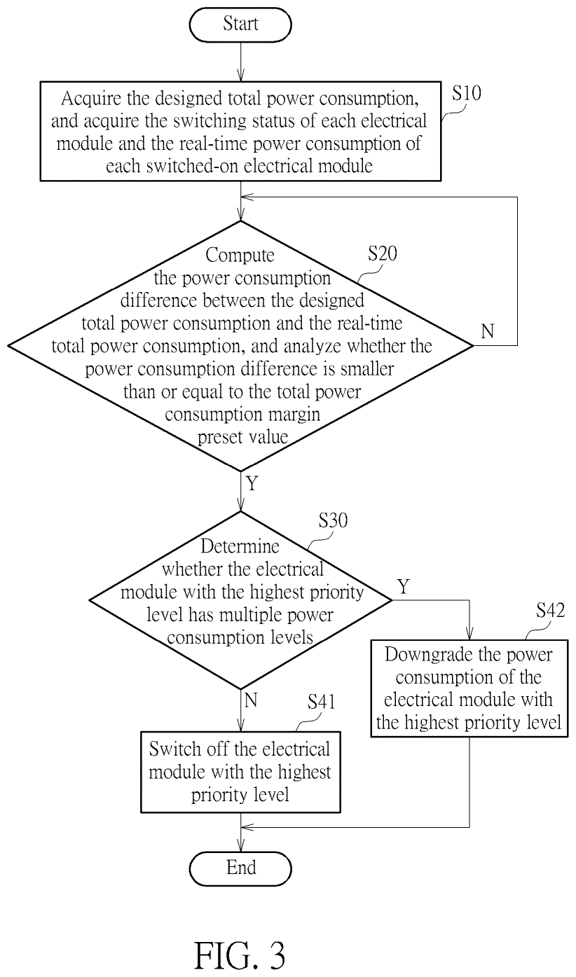

The configuration file stored in the storage module 30 can further include a priority level and a total power consumption margin preset value (such as 0.5 W) of each electrical module 10. The total power consumption margin preset value can indicate a power consumption difference between the designed total power consumption and the preset total power consumption of the electrical module 10. That is to say, the total power consumption margin preset value can be interpreted as a power consumption threshold. The foresaid protection mode can include: the processing module 20 can downgrade the real-time total power consumption when confirming that the power consumption difference between the designed total power consumption and the real-time total power consumption is smaller than or equal to the total power consumption margin preset value, which can be further explained as: calling the priority level, and switching off the corresponding electrical module based on the priority level; or, downgrading the power consumption of the corresponding electrical module based on the priority level. In the embodiment, steps of the processing module 20 determining whether to activate the protection mode and then controlling each electrical module 10 can be shown in FIG. 3.

In step S10, the processing module 20 can acquire the designed total power consumption from the configuration file, and acquire the switching status of each electrical module 10 and the real-time current (or the voltage) of each switched-on electrical module 10 in real time, and then compute the real-time power consumption of each switched-on electrical module 10, so as to compute the sum of the real-time power consumption of all of the switched-on electrical modules 10;

In step S20, the processing module 20 can analyze the power consumption difference between the designed total power consumption and the real-time total power consumption, and determine whether the power consumption difference is smaller than or equal to the total power consumption margin preset value (such as 0.5 W);

If the power consumption difference is greater than the total power consumption margin preset value, the remaining power consumption of the electronic device 100 is sufficient, and the processing module 20 does not adjust the working status of the electrical module 10 in operation, and then step S20 can be executed again to continuously monitor the remaining power consumption of the electronic device 100;

If the power consumption difference is smaller than or equal to the total power consumption margin preset value, the remaining power consumption of the electronic device 100 is insufficient, and the processing module 20 can further execute step S30 to decrease pressure of the circuit system of the electronic device 100. In step S30; the processing module 20 can determine whether the switched-on electrical module 10 with the highest priority level can have multiple power consumption levels;

If the processing module 20 confirms that the electrical module 10 with the highest priority level does not have the multiple power consumption levels, which means the electrical module 10 merely has two power statuses: on and off (for example, the network signal transmission module 10, connector module 10, etc.), step S41 can be executed: the processing module 20 can transmit the control command to the electrical module 10 with the highest priority level for switching off the electrical module 10;

If the processing module 20 confirms that the electrical module 10 with the highest priority level have the multiple power consumption levels, which means the real-time power consumption of the electrical module 10 is adjustable (for example, the audio module 10, the display module 10, etc.), step S42 can be executed: the processing module 20 can transmit the control command to the electrical module 10 with the highest priority level, for downgrading the power consumption level of the electrical module 10.

Preferably, the processing module 20 can execute step S20 again after execution of step S41 or step S42, so as to determine whether the remaining power consumption of the electronic device 100 is sufficient, and switch off the electrical module 10 with the second highest priority level (the electrical module 10 with the highest priority level is already switched off in step S41) when the remaining power consumption is still insufficient; or, the electrical module 10 with the highest priority level can be further downgraded based on the previous step S42; moreover, the electrical module 10 with the second highest priority level can be switched off when the power consumption level of the electrical module 10 with the highest priority level cannot be downgraded in accordance with the previous step S42, or, the power consumption level of the electrical module 10 with the second highest priority level can be downgraded, and so on.

In other embodiment, the processing module 20 can switch off the plurality of electrical modules 10 with the higher priority level, or downgrade the power consumption level of the plurality of electrical modules 10; variation of the foresaid embodiment can depend on a design demand, and the present application is not limited to the foresaid embodiment.

In other preferred embodiment, the electronic device 100 can further include a battery (which is not shown in the figures), that is to say, the battery of the electronic device 100 can provide electrical energy for driving the plurality of electrical modules 10. The battery can have corresponding battery endurance in accordance with the real-time total power consumption. The circuit monitoring module 40 can be coupled to the battery and used to acquire real-time electrical capacity of the battery. The configuration file can further include maximal electrical capacity of the battery. It should be mentioned that the maximal electrical capacity may be a constant value during a period, and also can be interpreted as preset code of the computer programs; but it is understandable that the maximal electrical capacity of the battery may be decreased over time, which is usually manifested as the maximum voltage value in response to the battery being fully charged, so that the processing module 20 can update the maximal electrical capacity in the configuration file when the maximum voltage value of the battery is decreased after being fully charged. The present application is not limited to the foresaid embodiment. The processing module 20 can compute the remaining electrical capacity value and/or the battery endurance in accordance with the real-time electrical capacity and the maximal electrical capacity. The real-time remaining electrical capacity value can be a ratio of the real-time electrical capacity to the maximal electrical capacity. The information displayed on the display module 10 can further include the battery endurance of the battery of the electronic device 100 based on the condition of the real-time total power consumption. In other embodiment, the information displayed on the display module 10 can further include the real-time remaining electrical capacity value of the battery; the present application is not limited to the foresaid embodiment.

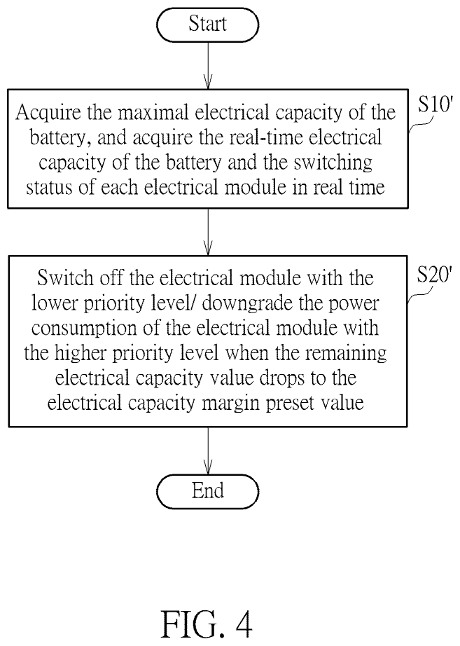

Preferably, the foresaid protection mode can further include: the processing module 20 can automatically adjust the switching status and/or the real-time power consumption of the corresponding electrical module 10 when the battery is low; which can also preset the priority level of each electrical module 10, and adjust the switching status and/or the real-time power consumption of the corresponding electrical module 10 based on the priority level. The same description is omitted herein for simplicity. Difference is that the configuration file can further include an electrical capacity margin preset value (such as 20%), and the electrical capacity margin preset value can be interpreted as an electrical capacity threshold of the battery. The processing module 20 can call the priority level when the real-time remaining electrical capacity value is detected to drop to the electrical capacity margin preset value, and can switch off the corresponding electrical module based on the priority level; or, the power consumption of the corresponding electrical module can be downgraded based on the priority level. In the preferred embodiment, steps of the processing module 20 controlling each electrical module 10 can be shown in FIG. 4.

In step S10′: the circuit monitoring module 40 can acquire the maximal electrical capacity of the battery, and can acquire the real-time electrical capacity of the battery and the switching status of each electrical module 10 in real time. The processing module 20 can compute the remaining electrical capacity value in accordance with the maximal electrical capacity and the real-time electrical capacity;

In step S20′, the processing module 20 can transmit the control command to the electrical module 10 with higher priority level (for example, its priority level can be set before the preset position) when monitoring the remaining electrical capacity value is decreased to drop to the electrical capacity margin preset value (such as 20%), so as to switch off the electrical module 10; it is understandable that the electrical module 10 with the lower priority level (for example, the priority level can be set after the preset position) usually needs to remain in the switched-on working status. The processing module 20 can transmit the command to the electrical module 10 with the lower priority level for downgrading the power consumption of the electrical module 10, such as lowering brightness of the backlight, the operation frequency of the processing module 20 and so on; application of the foresaid embodiment can depend on the design demand by the person skilled in the art, and the present application is not limited to the foresaid embodiment.

It should be mentioned step S10′ can be executed synchronously with the foresaid step S10; for example, the processing module 20 can execute the corresponding protection mode when any one of the real-time total power consumption and the real-time electrical capacity achieves a condition of executing the protection mode; further, the priority level of the real-time total power consumption can be set as being higher than the priority level of the real-time electrical capacity, which means the processing module 20 can always execute the foresaid protection mode when the real-time total power consumption is high, regardless of whether the remaining electrical capacity is sufficient; the present application is not limited to the foresaid embodiment.

In other embodiment, the preset mode can further include a performance mode; in the performance mode, the switched-on working status of each electrical module 10 can be kept even though the battery is low. That is to say, the user can press the corresponding preset mode control when the user does not need long battery endurance and each electrical module 10 of the electronic device 100 is still kept in the switched-on status, so that the processing module 20 does not automatically adjust the switching status and/or the real-time power consumption of the corresponding electrical module 10. Or, step S20′ terminates after the electronic device 100 is plugged into a charger. The present application is not limited to the foresaid embodiment.

In conclusion, the electronic device provided by the present application can include the plurality of electrical modules, the storage module, the circuit monitoring module and the processing module. The plurality of electrical modules can at least include the display module. The storage module can store the designed total power consumption of the electronic device. The circuit monitoring module can be respectively coupled to the plurality of electrical modules, and acquire the switching status of the plurality of electrical modules and the real-time current of the switched-on electrical module in real time. The processing module can analyze and acquire the real-time power consumption of the corresponding electrical module and the real-time total power consumption of the electronic device, in accordance with the real-time current of each switched-on electrical module; the processing module can determine whether to activate the protection mode based on the real-time total power consumption and the designed total power consumption. The processing module can be further coupled to the display module, and used to control the display module to display the information. The information can include the switching status, the real-time power consumption, the real-time total power consumption, and at least one of the designed total power consumption and the total power consumption margin of the plurality of electrical modules.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a plurality of electrical modules, at least comprising a display module;
a storage module adapted to store designed total power consumption of the electronic device;
a circuit monitoring module respectively coupled to the plurality of electrical modules, and adapted to immediately acquire switching statuses of the plurality of electrical modules and real-time current of each of switched-on electrical modules; and
a processing module coupled to the storage module and the circuit monitoring module, and adapted to analyze and acquire real-time power consumption corresponding to the electrical modules and real-time total power consumption of the electronic device in accordance with the real-time current of each of the switched-on electrical modules, the processing module being adapted to further determine whether to activate a protection mode in accordance with the real-time total power consumption and the designed total power consumption;
wherein the processing module is further coupled to the display module and adapted to control the display module to display information, the information comprises the switching statuses and the real-time power consumption of the plurality of electrical modules, the real-time total power consumption, and at least one of the designed total power consumption and total power consumption margin.

2. The electronic device of claim 1, wherein the electronic device further comprises an input module adapted to be operated for inputting an operation command, the operation command is adapted to change the switching statuses of the plurality of electrical modules, and/or adjust a power consumption level of each of the electrical modules.

3. The electronic device of claim 1, wherein the displayed information further comprises a plurality of switch controls, the plurality of switch controls comprises switch controls of at least parts of the plurality of electrical modules, and/or power consumption mode adjusting controls of the plurality of electrical modules; the plurality of switch controls is respectively operated for inputting a corresponding operation command.

4. The electronic device of claim 1, wherein the displayed information further comprises a preset mode control adapted to be operated for inputting a corresponding operation command, so as to adjust each of the electrical modules to a preset switching status and/or a preset power consumption level.

5. The electronic device of claim 1, wherein the storage module is adapted to further store a preset priority level and a total power consumption margin preset value of each of the electrical modules; the protection mode comprises: the processing module downgrades the real-time total power consumption when determining a power consumption difference between the designed total power consumption and the real-time total power consumption is smaller than or equal to the total power consumption margin preset value, which is interpreted as: firstly switching off at least one electrical module with a high priority level; or, firstly downgrading a power consumption level of at least one electrical module with the high priority level.

6. The electronic device of claim 5, wherein the protection mode further comprises: the processing module further confirms whether the electrical module with the high priority level has multiple power consumption levels; the processing module switches off the electrical module with the high priority level and not having the multiple power consumption levels; and the processing module downgrades the power consumption level of the electrical module with the high priority level and having the multiple power consumption levels.

7. The electronic device of claim 5, wherein the protection mode further comprises: the processing module further confirms an adjusted power consumption difference when confirming the power consumption difference between the designed total power consumption and the real-time total power consumption is smaller than or equal to total power consumption margin preset value and adjusting the real-time total power consumption, and downgrades the power consumption level of the electrical module with highest priority again when the adjusted power consumption difference is smaller than or equal to total power consumption margin preset value.

8. The electronic device of claim 5, wherein the protection mode further comprises: the processing module further confirms an adjusted power consumption difference when confirming the power consumption difference between the designed total power consumption and the real-time total power consumption is smaller than or equal to total power consumption margin preset value and adjusting the real-time total power consumption, and switches off the electrical module with second highest priority or downgrades the power consumption level of the electrical module with the second highest priority when the adjusted power consumption difference is smaller than or equal to total power consumption margin preset value.

9. The electronic device of claim 1, wherein the electronic device further comprises a battery adapted to provide electrical energy for the plurality of electrical modules, and the circuit monitoring module is coupled to the battery and adapted to acquire real-time electrical capacity of the battery; the information displayed on the display module further comprises a battery endurance of the electronic device in accordance with the real-time total power consumption.

10. The electronic device of claim 1, wherein the plurality of electrical modules further comprises one or some of an audio module, a network signal transmission module and a connector module.
